(19) United States
(12) Patent Application Publication
(10) Pub. No.: US 2002/0160749 A1
(43) Pub. Date: Oct. 31, 2002

(54) Data distributing method, data distributing system, computer, reproducing APPARTUS AND MEMORY PRODUCT

(76) Inventor: Youichiro Nishikawa, Katano-shi (JP)

Correspondence Address: Darby & Darby, 805 Third Avenue, New York, NY, 10022-7513, US

(21) Appl. No.: 09/979,686

(22) PCT Filed: May 21, 2001
(86) PCT No.: PCT/JP01/02267

(30) Foreign Application Priority Data
Mar. 24, 2000 (JP) 2000-84947

(51) Int. Cl. H04M 11/00

(52) U.S. Cl. 455/408

(57) ABSTRACT

An audio data distributing method for distributing audio data from a distributing server to a terminal unit by two-way communication. Audio data identification information and data of an audition period or number of auditions are sent from the terminal unit to the distributing server (P18, P24); the distributing server sends audio data of the received audio data identification information and the received data of an audition period or number of auditions to the terminal unit (P26) and charges the terminal unit according to the audio data and the audition period or number of auditions (P30); and the terminal unit disables reproduction of the received audio data when the audition period of the received data has expired or the number of auditions has been reached. Accordingly, it is possible to provide an audio data distributing method capable of offering a short-time audition, sale with a time limit and sale with a limited number of auditions at low prices.

### TECHNICAL FIELD

The present invention relates to a data distributing method and a data distributing system, for distributing various data, such as audio data like music, still image data and moving image data, to terminal units by two-way communication, a computer for use in this data distributing system, a reproducing apparatus for use in this data distributing system, and a memory product readable by computers and storing therein a computer program for causing a computer to receive data from an external apparatus by two-way communication.

### BACKGROUND ART

A music distributing system (audio data distributing system) capable of downloading music data through networks such as the Internet to terminal units, such as a special reproducing apparatus comprising a built-in MPU (Micro Processing Unit) type rewritable memory like a compact flash memory (CF memory) and personal computers, and allowing the terminal units to reproduce the downloaded music data has been spreading.

The currently spread music distribution system is of a type of selling out music data (the music data is purchased by the terminal units), and systems equivalent to a conventional compact disk renting method, such as a short-time audition, sale with a time limit and sale with a limited number of auditions at low prices, have not been realized.

Moreover, in addition to the above-mentioned music data, the same thing can be said about various data, for example, still image data and moving image data.

The present invention has been made in view of the above circumstances, and it is an object of the first through third inventions to provide a data distributing method capable of offering a short-time trial, sale with a time limit and sale with a limited number of trials at low prices.

It is an object of the fourth through sixth inventions to provide a data distributing system capable of offering a short-time trial, sale with a time limit and sale with a limited number of trials at low prices.

It is an object of the seventh through ninth inventions to provide a computer for use in a data distributing system capable of offering a short-time trial, sale with a time limit and sale with a limited number of trials at low prices.

It is an object of the tenth through twelfth inventions to provide a reproducing apparatus for a data distributing system capable of offering a short-time trial, sale with a time limit and sale with a limited number of trials at low prices.

It is an object of the thirteenth invention to provide a memory product readable by computers and storing therein a program capable of activating a computer, as a reproducing apparatus for a data distributing system capable of offering a short-time trial, sale with a time limit and sale with a limited number of trials at low prices.

### DISCLOSURE OF THE INVENTION

A data distributing method according to the first invention is a data distributing method for distributing data from a distributing server to a terminal unit by two-way communication, characterized in that: said terminal unit sends data identification information and data of a trial period or number of trials to said distributing server; said distributing server sends data of the received data identification information and the received data of a trial period or number of trials to said terminal unit and charge said terminal unit according to said data and said trial period or number of trials; and said terminal unit disables reproduction of said received data when the trial period of said received data has expired or the number of trials has been reached.

A data distributing method according to the second invention is based on the first invention and characterized in that: when a request to extend or add said trial period or number of trials is required from said terminal unit, said distributing server sends data of said trial period or number of trials extended or added to said terminal unit and additionally charges said terminal unit according to said trial period or number of trials; and said terminal unit updates the trial period or number of trials of said data according to the received data.

A data distributing method according to the third invention is based on the first or second invention and characterized in that: when a request to purchase said data is required from said terminal unit, said distributing server sends data for invalidating said data of the trial period or number of trials to said terminal unit and additionally charges said terminal unit according to said request; and said terminal unit invalidates said data of the trial period or number of trials according to the received data.

A data distributing system according to the fourth invention is a data distributing system for distributing data from a distributing server to a terminal unit by two-way communication, characterized in that: said distributing server comprises means for receiving data identification information and data of a trial period or number of trials from said terminal unit, means for sending data of the data identification information received by said means and the received data of a trial period or number of trials to said terminal unit, and means for charging said terminal unit according to said data and said trial period or number of trials; and said terminal unit comprises means for sending data identification information and data of a trial period or number of trials to said distributing server, means for receiving the data and data sent by said distributing server, and means for disabling reproduction of the data received by said means when the trial period of the data received by said means has expired or the number of trials has been reached.

According to the data distributing method of the first invention and the data distributing system of the fourth invention, data is distributed from a distributing server to a terminal unit by two-way communication. In the distributing server, the receiving means receives data identification information and data of a trial period or number of trials from the terminal unit, the sending means sends data of the received data identification information and the received data of a trial period or number of trials to the terminal unit, and the charging means charges the terminal unit according to the data and the trial period or number of trials. In the terminal unit, the sending means sends data identification information and data of a trial period or number of trials to the distributing server, the receiving means receives the data and the data sent by the distributing server, and the reproduction disabling means disables reproduction of the received data when the trial period of the received data has expired or the number of trials has been reached.

Accordingly, it is possible to realize a data distributing method and a data distributing system capable of offering a short-time trial, sale with a time limit and sale with a limited number of trials at low prices.

A data distributing system according to the fifth invention is based on the fourth invention and characterized in that: said distributing server further comprises means for receiving a request to extend or add said trial period or number of trials from said terminal unit, means for sending data of the trial period or number of trials extended or added according to the request received by said means to said terminal unit, and means for additionally charging said terminal unit according to said trial period or number of trials; and said terminal unit further comprises means for sending a request to extend or add the trial period or number of trials of said data to said distributing server, means for receiving the data sent by said distributing server, and means for updating the data of the trial period or number of trials of said data according to the data received by said means.

According to the data distributing method of the second invention and the data distributing system of the fifth invention, in the distributing server, the receiving means receives a request to extend or add the trial period or number of trials from the terminal unit, the sending means sends data of the trial period or number of trials extended or added according to the received request to the terminal unit, and the charging means additionally charges the terminal unit according to the trial period or number of trials. In the terminal unit, the sending means sends a request to extend or add the trial period or number of trials of the data to the distributing server, the receiving means receives the data sent by the distributing server, and the updating means updates the data of the trial period or number of trials of the data according to the received data.

Accordingly, it is possible to realize a data distributing method and a data distributing system capable of offering a short-time trial, sale with a time limit and sale with a limited number of trials at low prices and capable of allowing an extension of the time limit and an addition to the limited number of trials.

A data distributing system according to the sixth invention is based on the fourth or fifth invention and characterized in that: said distributing server further comprises means for receiving a request to purchase said data from said terminal unit, means for sending data for invalidating said data of the trial period or number of trials to said terminal unit when said means receives said request, and means for additionally charging said terminal unit according to said request; and said terminal unit further comprises means for sending a request to purchase said data to said distributing server, means for receiving the data sent by said distributing server, and means for invalidating said data of the trial period or number of trials according to the data received by said means.

According to the data distributing method of the third invention and the data distributing system of the sixth invention, in the distributing server, the receiving means receives a request to purchase the data from the terminal unit, the sending means sends data for invalidating the data of the trial period or number of trials of the data to the terminal unit upon receipt of the request, and the charging means additionally charges the terminal unit according to the request. In the terminal unit, the sending means sends a request to purchase the data to the distributing server, the receiving means receives data sent by the distributing server, and the invalidating means invalidates the data of the trial period or number of trials according to the received data.

Accordingly, it is possible to realize a data distributing method and a data distributing system capable of offering a short-time trial, sale with a time limit and sale with a limited number of trials at low prices and capable of allowing the terminal unit to purchase data before the time limit has expired or the limited number of trials has been reached.

A computer according to the seventh invention is a computer for distributing data to an external apparatus by two-way communication, characterized by comprising: means for receiving data identification information and data of a trial period or number of trials from said external apparatus; means for sending data of the data identification information received by said means and the received data of a trial period or number of trials to said external apparatus; and means for charging said external apparatus according to said data and said trial period or number of trials.

According to the computer of the seventh invention, data is sent to the external apparatus by two-way communication. The receiving means receives data identification information and data of a trial period or number of trials from the external apparatus, and the sending means sends data of the received data identification information and the received data of a trial period or number of trials to the external apparatus. The charging means charges the external apparatus according to the data and the trial period or number of trials.

Accordingly, it is possible to realize a computer for use in a data distributing system capable of offering a short-time trial, sale with a time limit and sale with a limited number of trials at low prices.

A computer according to the eighth invention is based on the seventh invention and characterized by further comprising: means for receiving a request to extend or add said trial period or number of trials from said external apparatus; means for sending data of the trial period or number of trials extended or added according to the request received by said means to said external apparatus; and means for additionally charging said external apparatus according to said trial period or number of trials.

According to the computer of the eighth invention, the receiving means receives a request to extend or add the trial period or number of trials from the external apparatus, and the sending means sends data of the trial period or number of trials extended or added according to the received request to the external apparatus. The charging means additionally charges the external apparatus according to the trial period or number of trials.

Accordingly, it is possible to realize a computer for use in a data distributing system capable of offering a short-time trial, sale with a time limit and sale with a limited number of trials at low prices and capable of allowing an extension of the time limit and an addition to the limited number of trials.

A computer according to the ninth invention is based on the seventh or eighth invention and characterized by further comprising: means for receiving a request to purchase said data from said external apparatus; means for sending data for invalidating said data of the trial period or number of trials to said external apparatus when said means receives said request; and means for additionally charging said external apparatus according to said request.

According to the computer of the ninth invention, the receiving means receives a request to purchase the data from the external apparatus, and the sending means sends data for invalidating the data of the trial period or number of trials to the external apparatus upon receipt of the request. The charging means additionally charges the external apparatus according to the request.

Accordingly, it is possible to realize a computer for use in a data distributing system capable of offering a short-time trial, sale with a time limit and sale with a limited number of trials at low prices and capable of allowing the terminal unit to purchase data before the time limit has expired or the limited number of trials has been reached.

A reproducing apparatus according to the tenth invention is a reproducing apparatus for receiving data from an external apparatus by two-way communication, characterized by comprising: means for sending data identification information and data of a trial period or number of trials to said external apparatus; means for receiving data and data of a trial period or number of trials from said external apparatus; and means for disabling reproduction of data received by said means when the trial period of the data received by said means has expired or the number of trials has been reached.

According to the reproducing apparatus of the tenth invention, data is received from the external apparatus by two-way communication. The sending means sends data identification information and the data of a trial period or number of trials to the external apparatus, and the receiving means receives the data and the data of a trial period or number of trials from the external apparatus. The reproduction disabling means disables reproduction of the received data when the trial period of the received data has expired or the number of trials has been reached.

Accordingly, it is possible to realize a reproducing apparatus for a data distributing system capable of offering a short-time trial, sale with a time limit and sale with a limited number of trials at low prices.

A reproducing apparatus according to the eleventh invention is based on the tenth invention and characterized by further comprising: means for sending a request to extend or add said trial period or number of trials to said external apparatus; means for receiving data of the trial period or number of trials extended or added according to said request from said external apparatus; and means for updating the data of the trial period or number of trials of said data according to the data received by said means.

According to the reproducing apparatus of the eleventh invention, the sending means sends a request to extend or add the trial period or number of trials to the external apparatus, and the receiving means receives data of the trial period or number of trials apparatus. The updating means updates the data of the trial period or number of trials of the data according to the received data.

Accordingly, it is. possible to realize a reproducing apparatus for a data distributing system capable of offering a short-time trial, sale with a time limit and sale with a limited number of trials at low prices and capable of allowing an extension of the time limit and an addition to the limited number of trials.

A reproducing apparatus according to the twelfth invention is based on the tenth or eleventh invention and characterized by further comprising: means for sending a request to purchase said data to said external apparatus; means for receiving data for invalidating said data of the trial period or number of trials from said external apparatus; and means for invalidating said data of the trial period or number of trials according to the data received by said means.

According to the reproducing apparatus of the twelfth invention, the sending means sends a request to purchase the data to the external apparatus, and the receiving means receives data for invalidating the data of the trial period or number of trials from the external apparatus. The invalidating means invalidates the data of the trial period or number of trials according to the received data.

Accordingly, it is possible to realize a reproducing apparatus for a data distributing system capable of offering a short-time trial, sale with a time limit and sale with a limited number of trials at low prices and capable of allowing the reproducing apparatus to purchase data before the time limit has expired or the limited number of trials has been reached.

A memory product according to the thirteenth invention is a memory product readable by a computer and storing therein a computer program for receiving data from an external apparatus by two-way communication, characterized by storing therein a computer program including: program code means for causing said computer to send data identification information and data of a trial period or number of trials to said external apparatus; program code means for causing said computer to receive data and the data of the trial period or number of trials from said external apparatus; and program code means for causing said computer to disable reproduction of the data received by said computer when the trial period of the received data has expired or the number of trials has been reached.

According to the memory product of the thirteenth invention, a computer that has read the computer program stored in the memory product receives data from an external apparatus by two-way communication. The computer sends data identification information and data of a trial period or number of trials to the external apparatus and receives the data and the data of the trial period or number of trials from a distributing server. The computer disables reproduction of the received data when the trial period of the received data has expired or the number of trials has been reached.

Accordingly, by causing a computer to read the stored computer program, it is possible to realize a reproducing apparatus for a data distributing system capable of offering a short-time trial, sale with a time limit and sale with a limited number of trials at low prices.

### BRIEF DESCRIPTION OF THE DRAWINGS

FIG. 1 is a block diagram showing the structures of an audio data distributing method, an audio data distributing system, a computer and a player as embodiments of a data distributing method, a data distributing system, a computer and a reproducing apparatus according to the present invention; FIG. 2 is an explanatory view for explaining a flow of processing performed by a terminal unit and a distributing server; FIG. 3 is an explanatory view for explaining a flow of processing performed by a terminal unit and a distributing server; FIG. 4 is an explanatory view for explaining an example of the format for sending music data as data and the data of a trial period as an audition period from a distributing server; FIG. 5 is an explanatory view for explaining an example of the image of an audition-period data storage unit as a trial data storage unit; FIG. 6 is an explanatory view for explaining a flow of processing performed by a terminal unit and a distributing server; and FIG. 7 is a schematic view showing the structure of another embodiment.

### BEST MODE FOR CARRYING OUT THE INVENTION

The following description will explain the present invention with reference to the drawings illustrating embodiments thereof

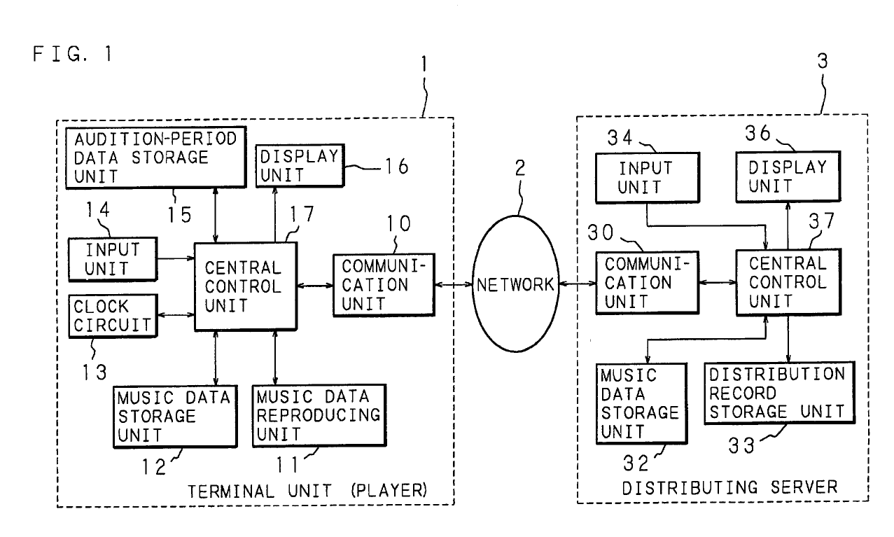

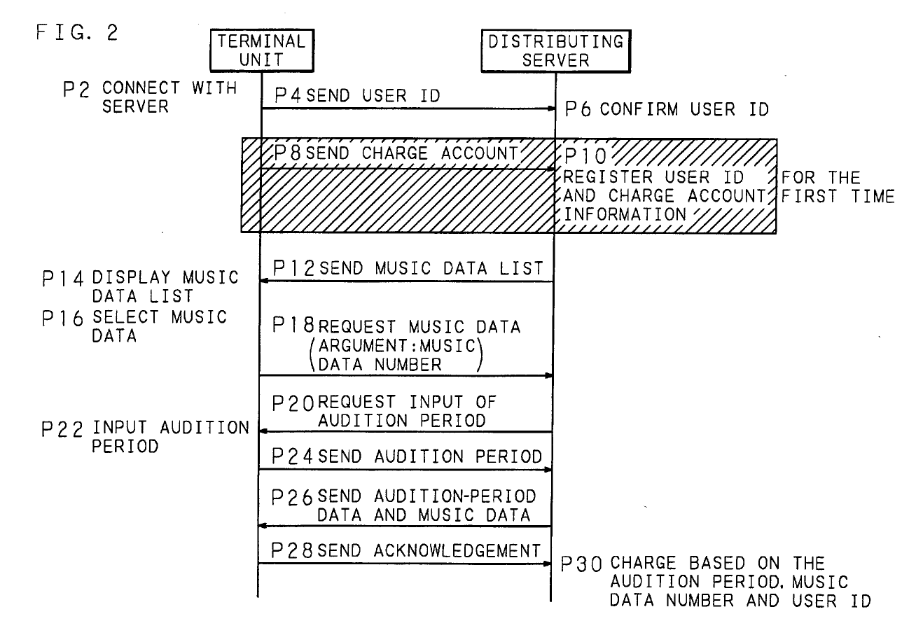

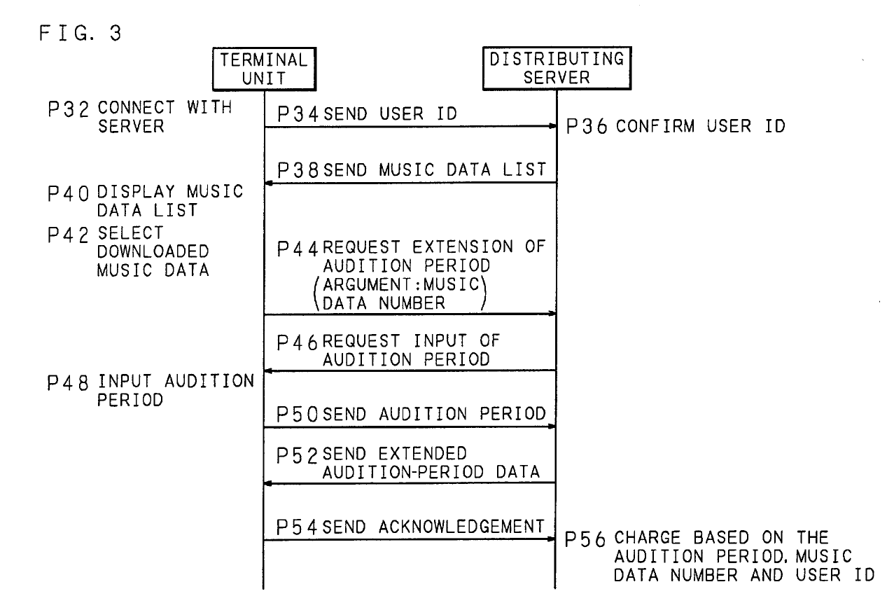

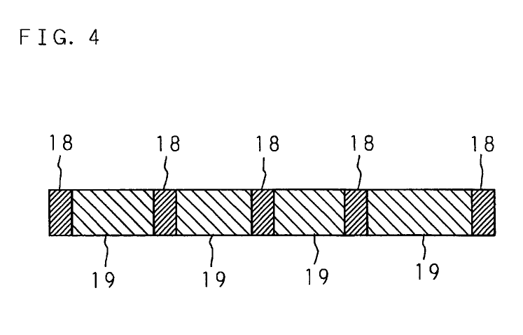

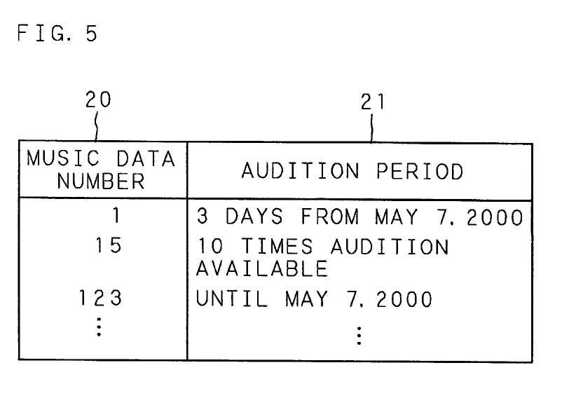

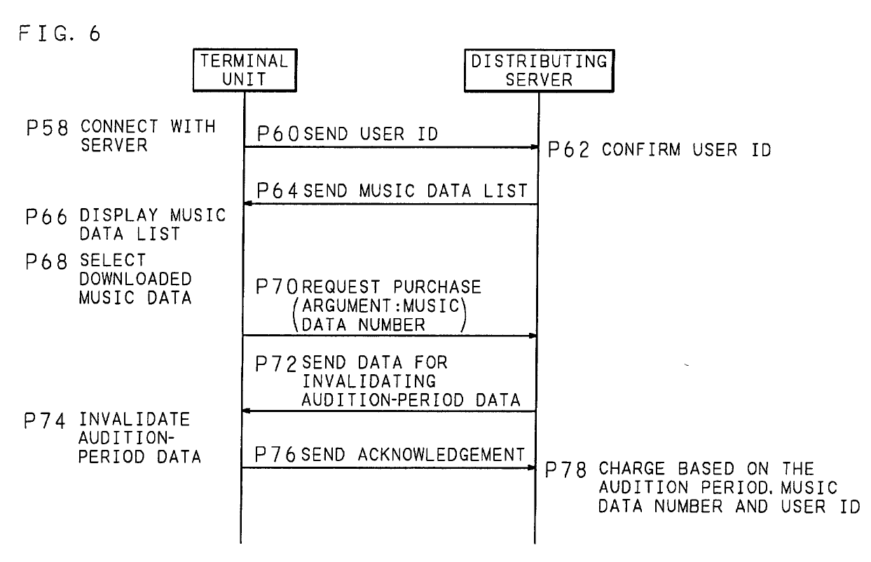

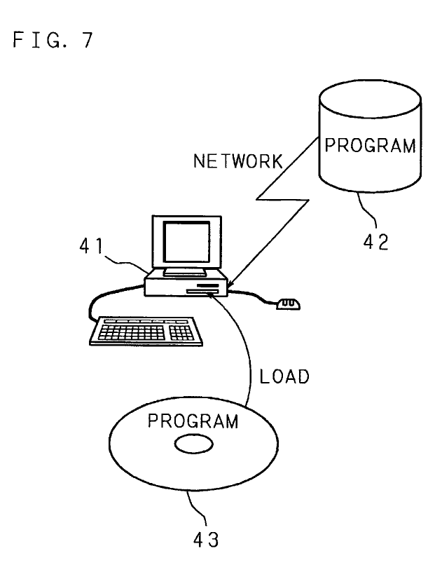

FIG. 1 is a block diagram showing the structures of an audio data distributing method, an audio data distributing system, a computer and a player as embodiments of a data distributing method, a data distributing system, a computer and a reproducing apparatus according to the present invention. In this audio data distributing system, many terminal units 1 as players are connected to a distributing server 3 as a computer by two-way communication through a network 2 such as the Internet and public switched network.

The distributing server 3 comprises a communication controlling unit 30 for making communication connections with many terminal units 1 through the network 2; a music data storage unit 32 for storing a large number of music data (audio data) for distribution; a distribution record storage unit 33 for storing a distribution record as the contents distributed to the terminal units 1; an input unit 34 such as a keyboard and a disk drive; a display unit 36 having a display screen; and a central control unit 37 for sending/receiving signals to/from the respective units and controlling these units.

The terminal device 1 comprises a communication control unit 10 for making communication connections with the distributing server 3 and other terminal units through the network 2; a music data storage unit 12 for storing music data (audio data) distributed from the distributing server 3; an audition-period data storage unit 15 for storing data of an audition period and the number of auditions of each music data stored in the music data storage unit 12 received from the distributing server 3; a music data reproducing unit 11 for reproducing music data stored in the music data storage unit 12; an input unit 14 such as input keys; a display unit 16 having a liquid crystal display screen; a clock circuit 13; and a central control unit 17 for sending/receiving signals to/from the respective units and controlling these units.

Referring to FIG. 2, FIG. 3 and FIG. 6 for explaining a flow of processing performed by the terminal unit 1 and the distributing server 3, the following description will explain the operation of the audio data distributing system having such structures.

First, when a user of a terminal unit 1 connects to the distributing server 3 through the network 2 (P2), the user ID identifying the user of the terminal unit 1 is sent (P4). The distributing server 3 receives this user ID, and collates it with the distribution record in the distribution record storage unit 33 for confirmation (P6).

When the user of the terminal unit 1 connects the distributing server 3 and uses the music distribution for the first time, the user's charge account information such as a credit card number is inputted through the input unit 14 and sent it (P8). The distributing server 3 receives this charge account information, and registers it together with the previously received user ID (P6) into the distribution record in the distribution record storage unit 33 (P10).

Next, the distributing server 3 sends a title list of music data available for distribution stored in the music data storage unit 32 to the terminal unit 1 (P12). The terminal unit 1 receives this title list of music data and displays it on the display unit 16 (P14). At this time, if there is music data that has already been stored in the music data storage unit 12, the display unit 16 makes its title in the title list distinguishable by black-and-white inverted display, etc.

The user selects desired music data from the music data list displayed on the display unit 16 (P14) through the input unit 14 (P16), and the terminal unit 1 sends the argument (music data number or audio data identification information) of the selected music data to request the music data (P18).

When the distributing server 3 receives the argument of the music data, it sends a message for requesting an input of the audition period of the music data to the terminal unit 1 (P20).

The terminal unit 1 receives this request message and displays it on the display unit 16. The user inputs a desired audition period through the input unit 14 in response to the request message displayed on the display unit 16, and the terminal unit 1 sends the inputted audition period (P24).

When the distributing server 3 receives the audition period from the terminal unit 1, it sends the music data requested by the terminal unit 1 (P18) and the data of the received audition period to the terminal unit 1 (P26).

The terminal unit 1 receives the music data and the data of the audition period, displays the title of the music data and the data of the audition period on the display unit 16, stores the music data in the music data storage unit 12, and stores the data of the audition period in the audition-period data storage unit 15.

The user confirms the title of the music data and the audition period displayed on the display unit 16, inputs an acknowledgement of receipt of the data through the input unit 14, and the terminal unit 1 sends the inputted acknowledgement message (P28).

When the distributing server 3 receives the acknowledgement message from the terminal unit 1, it charges a fee to the charge account registered into the distribution record in the distribution record storage unit 33 (P10), based on the music data and the audition period (P30).

FIG. 4 is an explanatory view for explaining an example of the format for sending music data and data of an audition period from the distributing server 3. In this format, the distributing server 3 recombines music data 19 and audition-period data 18 at random with the user ID as a key so as to concatenate single data.

This prevents the user from extracting only the music data illegally from the sent music data and audition-period data. Besides, even when the distributing server 3 sends only data of an audition period for extension of the audition period, it performs recombination processing so as to prevent falsification of the data.

The terminal unit 1 brings the received music data and audition-period data back into the normal form and store them in the music data storage unit 12 and audition-period data storage unit 15, respectively.

FIG. 5 is an explanatory view for explaining an example of the image of the audition-period data storage unit 15. The audition-period data storage unit 15 stores the music data number stored in the music data storage unit 12 in a music data number column 20, and stores their audition period in an audition period column 21 in association with the music data number. The audition period can be displayed by a period such as three days, a time limit such as March 7, the number of times of reproduction such as 10 times, etc.

When the central control unit 17 receives a request from the music data reproducing unit 11 to reproduce the music data, the terminal unit 1 compares the clock circuit 13 and the period or the time limit, and does not reproduce the data if the period or the time limit has expired. When the audition period is displayed by the number of times of reproduction, the central control unit 17 subtracts one from the number of times of reproduction stored for the music data in the audition-period data storage unit 15 every time the music data is reproduced.

Moreover, when the power of the central control unit 17 is switched on, for example, the terminal unit 1 checks the audition-period data in the audition-period data storage unit 15 and deletes music data whose period has expired and music data whose time limit has expired from the music data storage unit 12.

When the user of the terminal unit 1 wishes to extend the audition period of music data among the music data stored in the music data storage unit 12, it connects to the distributing server 3 through the network 2 (P32 in FIG. 3) and sends the user ID identifying the user of the terminal unit 1 (P34). The distributing server 3 receives this user ID and collates it with the distribution record in the distribution record storage unit 33 for confirmation (P36).

Next, the distributing server 3 sends the title list of music data stored in the music data storage unit 32 to the terminal unit 1 (P38). The terminal unit 1 receives this title list of music data and displays it on the display unit 16 (P40). At this time, if there is music data that has already been stored in the music data storage unit 12, the display unit 16 makes its title in the title list distinguishable by black-and-white inverted display, etc.

The user selects the argument of the music data that he/she wishes to extend the audition period in the music data stored (downloaded) in the music data storage unit 12 from the music data list displayed on the display unit 16 (P40) through the input unit 14(P42), and the terminal unit 1 sends the argument (music data number, audio data identification information) of the selected music data so as to request an extension of the audition period (P44).

When the distributing server 3 receives the argument of the music data, it sends a message for requesting an input of a desired audition period for extension of the music data to the terminal unit 1 (P46).

The terminal unit 1 receives this request message and displays it on the display unit 16. The user inputs a desired audition period for extension through the input unit 14 in response to the request message displayed on the display unit 16, and the terminal unit 1 sends the inputted desired audition period for extension (P50).

When the distributing server 3 receives the desired audition period for extension from the terminal unit 1, it sends data of the audition period extended based on the received audition period to the terminal unit 1 (P52).

The terminal unit 1 receives the data of the extended audition period, displays the data of the extended audition period on the display unit 16, and updates the original audition-period data in the audition-period data storage unit 15 according to the data of the extended audition period.

The user confirms the extended audition period displayed on the display unit 16 and inputs an acknowledgement of receipt of the data through the input unit 14, and the terminal unit 1 sends the inputted acknowledgement message (P54).

When the distributing server 3 receives the acknowledgement message from the terminal unit 1, it additionally charges a fee to the charge account registered into the distribution record in the distribution record storage unit 33 (P10 in FIG. 2), based on the music data and the extended audition period (P56).

When the user of the terminal unit 1 wishes to purchase music data among the music data stored in the music data storage unit 12, he/she connects to the distributing server 3 through the network 2 (P58 in FIG. 2), and sends the user ID identifying the user of the terminal unit 1 (P60). The distributing server 3 receives this user ID and collates it with the distribution record in the distribution record storage unit 33 for confirmation (P62).

Next, the distributing server 3 sends the title list of the music data stored in the music data storage unit 32 to the terminal unit 1 (P64). The terminal unit 1 receives this title list of the music data and displays it on the display unit 16 (P66). At this time, if there is music data that has already been stored in the music data storage unit 12, the display unit 16 makes its title in the title list distinguishable by black-and-white inverted display, etc.

The user selects the argument of music data that he/she wishes to purchase in the music data stored (downloaded) in the music data storage unit 12 from the music data list displayed on the C display unit 16 (P66) through the input unit 14 (P68), and the terminal unit 1 sends the argument (music data number, audio data identification information) of the selected music data so as to request the purchase (P70).

When the distributing server 3 receives the request for the purchase of the music data from the terminal unit 1, it sends data for invalidating the audition-period data of the music data requested to sell to the terminal unit 1 (P72).

The terminal unit 1 receives the data for invalidating the audition-period data of the music data, displays a message to invalidate the audition-period data of the music data on the display unit 16, and deletes the audition-period data of the music data in the audition-period data storage unit 15 to invalidate the audition-period data (P74).

The user confirms the message to invalidate the audition-period data displayed on the display unit 16 and inputs an acknowledgement of receipt of the data for invalidation through the input unit 14, and the terminal unit 1 sends the inputted acknowledgement message (P76).

When the distributing server 3 receives the acknowledgement message from the terminal unit 1, it additionally charges a fee for the difference, for example, to the charge account registered into the distribution record in the distribution record storage unit 33 (P10 in FIG. 2), based on the purchase price of the music data and the charge for the audition period (P78).

Note that the above-described embodiments mainly suppose a terminal unit 1 (player) for use exclusively in a music data distributing system, but, as shown in FIG. 7, it is, of course, possible to record a computer program for performing the same operation as the above-described terminal unit 1 on a removable memory product 43 such as a magnetic disk and CD-ROM, or download the computer program from a memory product, for example, a memory 42 provided in a connected center such as the distributing server 3 that can communicate the computer program with a personal computer 41 by radio or cable and activate the personal computer 41 as a terminal of this music data distributing system like the terminal unit 1.

Moreover, although the above-described embodiments mainly suppose a music data distributing system, it is needless to say that the present invention is applicable not only to a distributing system of music data, but also to a distributing system of various data, such as still image data and moving image data.

Industrial Applicability

According to the data distributing method of the first invention and the data distributing system of the fourth invention, it is possible to realize a data distributing method and a data distributing system capable of offering a short-time trial, sale with a time limit and sale with a limited number of trials at low prices.

According to the data distributing method of the second invention and the data distributing system of the fifth invention, it is possible to realize a data distributing method and a data distributing system capable of offering a short-time trial, sale with a time limit and sale with a limited number of trials at low prices and capable of allowing an extension of the time limit and an addition to the limited number of trials.

According to the data distributing method of the third invention and the data distributing system of the sixth invention, it is possible to realize a data distributing method and a data distributing system capable of offering a short-time trial, sale with a time limit and sale with a limited number of trials at low prices and capable of allowing the terminal unit to purchase data before the time limit has expired or the limited number of trials has been reached.

According to the computer of the seventh invention, it is possible to realize a computer for use in a data distributing system capable of offering a short-time trial, sale with a time limit and sale with a limited number of trials at low prices.

According to the computer of the eighth invention, it is possible to realize a computer for use in a data distributing system capable of offering a short-time trial, sale with a time limit and sale with a limited number of trials at low prices and capable of allowing an extension of the time limit and an addition to the limited number of trials.

According to the computer of the ninth invention, it is possible to realize a computer for use in a data distributing system capable of offering a short-time trial, sale with a time limit and sale with a limited number of trials at low prices and capable of allowing the terminal unit to purchase data before the time limit has expired or the limited number of trials has been reached.

According to the reproducing apparatus of the tenth invention, it is possible to realize a reproducing apparatus for a data distributing system capable of offering a short-time trial, sale with a time limit and sale with a limited number of trials at low prices.

According to the reproducing apparatus of the eleventh invention, it is possible to realize a reproducing apparatus for a data distributing system capable of offering a short-time trial, sale with a time limit and sale with a limited number of trials at low prices and capable of allowing an extension of the time limit and an addition to the limited number of trials.

According to the reproducing apparatus of the twelfth invention, it is possible to realize a reproducing apparatus for a data distributing system capable of offering a short-time trial, sale with a time limit and sale with a limited number of trials at low prices and capable of allowing the reproducing apparatus to purchase data before the time limit has expired or the limited number of trials has been reached.

According to a computer that has read the computer program stored in the memory product of the thirteenth invention, it is possible to realize a reproducing apparatus for a data distributing system capable of offering a short-time trial, sale with a time limit and sale with a limited number of trials at low prices.

1. A data distributing method for distributing data from a distributing server to a terminal unit by two-way communication, characterized in that:
said terminal unit sends data identification information and data of a trial period or number of trials to said distributing server;
said distributing server sends data of the received data identification information and the received data of a trial period or number of trials to said terminal unit and charge said terminal unit according to said data and said trial period or number of trials; and
said terminal unit disables reproduction of said received data when the trial period of said received data has expired or the number of trials has been reached.

2. The data distributing method as set forth in claim 1, characterized in that:
when a request to extend or add said trial period or number of trials is required from said terminal unit, said distributing server sends data of said trial period or number of trials extended or added to said terminal unit and additionally charges said terminal unit according to said trial period or number of trials; and
said terminal unit updates the trial period or number of trials of said data according to the received data.

3. The data distributing method as set forth in claim 1 or 2, characterized in that:
when a request to purchase said data is required from said terminal unit, said distributing server sends data for invalidating said data of the trial period or number of trials to said terminal unit and additionally charges said terminal unit according to said request; and
said terminal unit invalidates said data of the trial period or number of trials according to the received data.

4. A data distributing system for distributing data from a distributing server to a terminal unit by two-way communication, characterized in that:
said distributing server comprises means for receiving data identification information and data of a trial period or number of trials from said terminal unit, means for sending data of the data identification information received by said means and the received data of a trial period or number of trials to said terminal unit, and means for charging said terminal unit according to said data and said trial period or number of trials; and
said terminal unit comprises means for sending data identification information and data of a trial period or number of trials to said distributing server, means for receiving the data and data sent by said distributing server, and means for disabling reproduction of the data received by said means when the trial period of the data received by said means has expired or the number of trials has been reached.

5. The data distributing system as set forth in claim 4, characterized in that:
said distributing server further comprises means for receiving a request to extend or add said trial period or number of trials from said terminal unit, means for sending data of the trial period or number of trials extended or added according to the request received by said means to said terminal unit, and means for additionally charging said terminal unit according to said trial period or number of trials; and
said terminal unit further comprises means for sending a request to extend or add the trial period or number of trials of said data to said distributing server, means for receiving the data sent by said distributing server, and means for updating the data of the trial period or number of trials of said data according to the data received by said means.

6. The data distributing system as set forth in claim 4 or 5, characterized in that:
said distributing server further comprises means for receiving a request to purchase said data from said terminal unit, means for sending data for invalidating said data of the trial period or number of trials to said terminal unit when said means receives said request, and means for additionally charging said terminal unit according to said request; and
said terminal unit further comprises means for sending a request to purchase said data to said distributing server, means for receiving the data sent by said distributing server, and means for invalidating said data of the trial period or number of trials according to the data received by said means.

7. A computer for distributing data to an external apparatus by two-way communication, characterized by comprising:
means for receiving data identification information and data of a trial period or number of trials from said external apparatus;
means for sending data of the data identification information received by said means and the received data of a trial period or number of trials to said external apparatus; and
means for charging said external apparatus according to said data and said trial period or number of trials.

8. The computer as set forth in claim 7, characterized by further comprising:
means for receiving a request to extend or add said trial period or number of trials from said external apparatus;
means for sending data of the trial period or number of trials extended or added according to the request received by said means to said external apparatus; and
means for additionally charging said external apparatus according to said trial period or number of trials.

9. The computer as set forth in claim 7 or 8, characterized by further comprising:
means for receiving a request to purchase said data from said external apparatus;
means for sending data for invalidating said data of the trial period or number of trials to said external apparatus when said means receives said request; and
means for additionally charging said external apparatus according to said request.

10. A reproducing apparatus for receiving data from an external apparatus by two-way communication, characterized by comprising:
means for sending data identification information and data of a trial period or number of trials to said external apparatus;
means for receiving data and data of a trial period or number of trials from said external apparatus; and
means for disabling reproduction of data received by said means when the trial period of the data received by said means has expired or the number of trials has been reached.

11. The reproducing apparatus as set forth in claim 10, characterized by further comprising:
means for sending a request to extend or add said trial period or number of trials to said external apparatus;
means for receiving data of the trial period or number of trials extended or added according to said request from said external apparatus; and
means for updating the data of the trial period or number of trials of said data according to the data received by said means.

12. The reproducing apparatus as set forth in claim 10 or 11, characterized by further comprising:
means for sending a request to purchase said data to said external apparatus;
means for receiving data for invalidating said data of the trial period or number of trials from said external apparatus; and
means for invalidating said data of the trial period or number of trials according to the data received by said means.

13. A memory product readable by a computer and storing therein a computer program for receiving data from an external apparatus by two-way communication, characterized by storing therein a computer program including:
program code means for causing said computer to send data identification information and data of a trial period or number of trials to said external apparatus;
program code means for causing said computer to receive data and the data of the trial period or number of trials from said external apparatus; and
program code means for causing said computer to disable reproduction of the data received by said computer when the trial period of the received data has expired or the number of trials has been reached.
